(19) United States
(12) Patent Application Publication
(10) Pub. No.: US 2019/0046392 A1
(43) Pub. Date: Feb. 14, 2019

(54) Tetrahedral Massage Device

(71) Applicant: Simple City LLC, Chicago, IL (US)

(72) Inventor: Phoebe Evans, Chicago, IL (US)

(21) Appl. No.: 16/101,222

(22) Filed: Aug. 10, 2018

Related U.S. Application Data
(60) Provisional application No. 62/545,469, filed on Aug. 14, 2017.

(51) Int. Cl. A61H 7/00

(52) U.S. Cl. CPC A61H 7/003; A61H 2201/0153; A61H 2201/1695; A61H 2201/0214; A61H 2201/1253; A61H 2201/0207

(57) ABSTRACT

A tetrahedral trigger point massage tool with multiple, unique sized radii as its corners is disclosed. The unique shape with the various radii allows several types of massage pressure to be applied based on distinct surface areas and depths of each corner. This enables the tool to treat several parts of the body, giving the user adjustable choices for whatever self-massage therapy they need. The device has flat surfaces directly across from the different radii that enable self-treatment using any hard surface (i.e., floors, walls, chairs, etc.) and comfortably fits within a user's hand. The material is durable and effective at balancing massage depth while minimizing pain.

### PRIORITY CLAIM

The present application claims priority from U.S. Provisional Application No. 62/545,469, filed Aug. 14, 2017. The contents of that application are hereby incorporated by reference in their entirety.

### TECHNICAL FIELD

The present disclosure relates generally to the field of massage devices. More particularly, a hand-held personal massage device used to help alleviate myofascial pain is disclosed.

### BACKGROUND

Myofascial trigger point therapy is a common method of treating muscular pain that is growing in popularity. Such therapy is primarily used by physical and massage therapists, athletic trainers, and chiropractors to relieve muscular pain and improve mobility. Myofascial release therapy has been proven to be a very safe and effective technique involving sustained pressure on dysfunctional myofascial connective tissue restrictions, also called “knots” or trigger points, to eliminate pain and increase range of motion in the body. This dysfunctional fascia can be caused by poor motor patterns (i.e. sitting at a computer for a sustained period of time), strenuous exercise without the proper recovery time, stress and other conditions. The sustained pressure of myofascial release therapy is uncomfortable but is generally not excruciating. Once pressure has been put on the dysfunctional area for the correct amount of time, often about 30 seconds, the person should feel the knot dissolve away or “release.” Because everyone's body and pain tolerances are different, the most effective amount of force varies from person to person. The myofascial pressure can relax contracted muscles, improve lymphatic and blood flows and stimulate stretch reflexes within targeted muscles. A person with limited range of motion often causing pain may benefit from more frequent, self-treatment tools to maintain typical functioning status in lieu of being reliant on regular trips to expensive medical professionals.

Current trigger point treatment devices for myofascial therapy include balls, rollers, canes and mechanical vibrators. Some of the more effective tools make on the go self-treatment difficult due to their large or irregular size which limits where self-treatment can be performed. For example, canes can be bulky and awkward instruments that are too conspicuous for most professional and athletic situations. Similarly, balls and rollers typically have a singular contoured shape that can be less than ideal in treating various trigger point pains across a user's body. Singular, contoured shapes such as a ball or cylinder are helpful for massaging an entire muscle but can often be ineffective at targeting specific myofascial knots. However, balls often roll around in too large and uncontrolled of an area instead of sustaining pressure on one spot. Balls can even roll away from the user entirely if used against a hard surface, and are especially unwieldy when using on parts of the body that are difficult to reach.

With back pain becoming a larger issue for people confined to a desk or in front of a computer for large portions of the day, myofascial trigger point therapy is becoming popular. For example, people often pin a ball against a wall to target difficult to reach areas of the back, neck, and side. Unfortunately, if the ball rolls to the wrong area it can be difficult to re-position it correctly so that the exercise is effective. Similarly, users can also become frustrated if their rolling device falls or is propelled away due to unstable force upon the device by the user. Given the current alternatives, there is a need for a myofascial pain-relieving device that enables easy and effective self-treatment while maintaining practicality in terms of portability and approachableness. There is a further need for a myofascial pain-relieving device that allows flexibility in treating different areas of a body. There is also a need for a myofascial pain-relieving device that may be easily held in place by a user.

### SUMMARY

A tetrahedral, solid and asymmetric trigger point massage tool with a plurality of unique radii at its corners and a base configured to be grasped within a user's hand is disclosed.

An example uniquely shaped massage tool with different sized radii allows several types of user controlled pressure to be applied based on the size of the radii at each corner is disclosed. The smaller the radii, the deeper the tool can get into a muscle and the more painful the exercise. Larger radii on the tool target shallower pain points, which is often helpful for larger muscles (i.e., quadriceps and hamstrings). The various radii of the example massage tool also allow users to start shallower and then work their way up to deeper, more effective targeted massages. The multi-radii form enables the example tool to be employed in treating several parts of the body, giving the user adjustable choices for any type of self-massage therapy they need. The device has flat surfaces directly across from the different radii that enable self-treatment using any hard surface (i.e. floor, wall, chair, etc.) and the device comfortably fits within a user's hand.

The example massage tool may be used in several ways. A user can choose any of the four corners with various radius sizes based on their preferred pressure level. Each different corner will provide a different depth and breadth of pressure given the different radius sizes that are suitable for different parts of the body. Some users may prefer the smallest radius for the deeper myofascial knots while the largest radius should provide relief for the wider but less deep knots. An objective of the present device is to provide a flexible, unique solution to be applied to various myofascial muscular pains to as many body parts and individuals as possible.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

FIG. 1 is a perspective view of the example massage tool;

FIG. 2 is a perspective side view of the largest of the flat sides of the example massage tool in FIG. 1;

FIG. 3 is a perspective side view of the second largest of the flat sides of the example massage tool in FIG. 1;

FIG. 4 is a perspective side view of the third largest of the flat sides of the example massage tool in FIG. 1;

FIG. 5 is a perspective side view of the smallest of the flat sides of the example massage tool in FIG. 1;

FIG. 6 is a perspective view of the largest radii of the example massage device in FIG. 1;

FIG. 7 is a perspective view of the second largest radii of the example massage device in FIG. 1;

FIG. 8 is a perspective view of the third largest radii of the example massage device in FIG. 1;

FIG. 9 is a perspective view of the smallest radii of the example massage device in FIG. 1;

FIG. 10 is a side view of the example massage device in FIG. 1;

FIG. 11 is a perspective view with the smallest radii facing upward with a full view of the second smallest radii of the example massage device in FIG. 1;

FIG. 12 is a 120 degree counterclockwise rotation of FIG. 11 showing a perspective view of the example massage device in FIG. 1;

FIG. 13 is a perspective view with the smallest radii facing upward of the example massage device in FIG. 1;

FIG. 14 is a perspective view with the second largest radii facing upward of the example massage device in FIG. 1;

FIG. 15 shows the example massage device applied to a user's back held up against a wall;

FIG. 16 shows the example massage device applied to a user's leg on top of a chair;

FIG. 17 shows the example massage device applied to a user's foot against the floor; and

FIG. 18 is a perspective view of the largest corner radius with dotted lines to represent the other radii of the example massage device.

### DETAILED DESCRIPTION

A massage device is disclosed with a generally tetrahedral shaped working surface and a planar base made to fit easily in a user's hand or sit on any flat surface (wall, floor, chair, etc.). The unique radii corners concentrate different amounts of pressure on the user's body, enabling various myofascial massage opportunities that can tailored to each user's needs.

Referring now in more detail, FIG. 1 shows a perspective view of an example massage tool device 100. The example massage device 100 includes several flat surfaces such as surfaces 110, 112, 114 and 116. The surface 112 is bounded by roughly linear edges 118, 122 and 126. The surface 110 is bounded by edges 118, 120 and 124. In this example, the edges 118, 120, 122, 124 and 126 are filleted and range from 2 to 4 inches in length. The edges 118, 120, 122, 124 and 126 have roughly 50 to 70 degree angles connecting them, differing based on the corner size. These specific dimensions in this example are chosen to provide the largest range of radii versatility while still being able to comfortably fit in the average hand of a user. Of course, other dimensions may be used. In this example, each edge 118, 120, 122, 124 and 126 is bounded by respective corners 102, 104, 106 and/or 108, each with a unique radius.

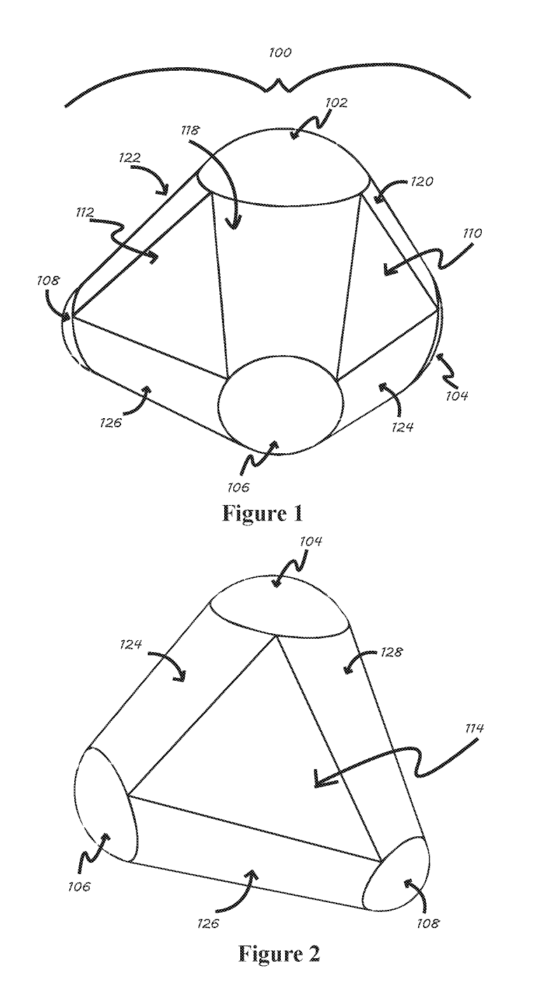

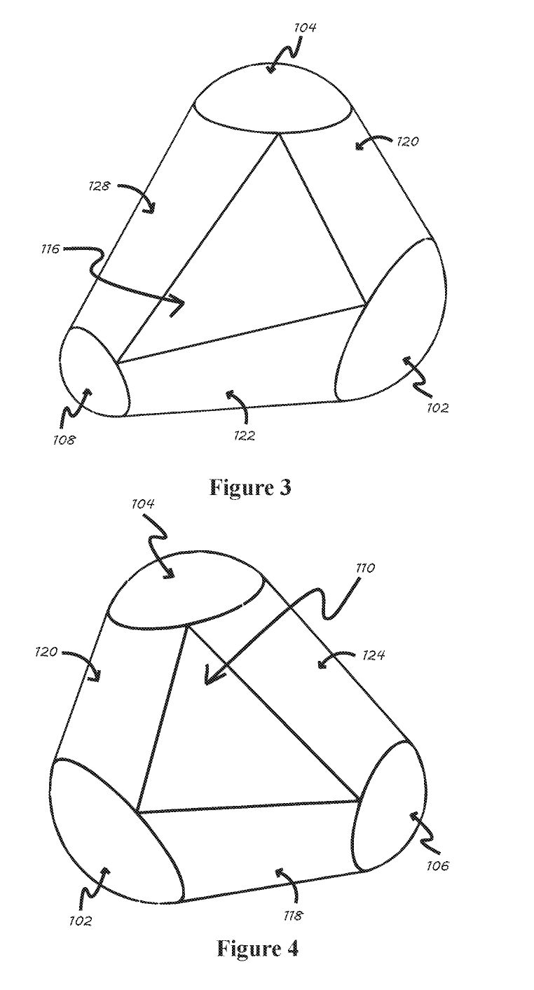

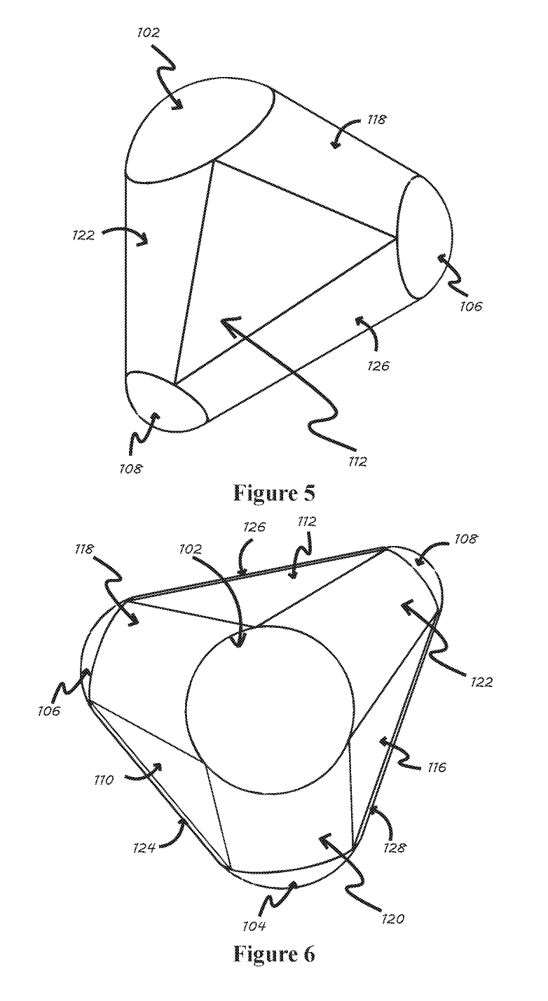

FIGS. 2-5 are various views of the flat, approximately triangular shaped surfaces 112, 114 and 116 that illustrate additional features of the massage device 100. FIG. 2 shows the surface 114 bounded by edges 124, 126 and 128 and corners 104, 106 and 108. FIG. 3 shows the surface 116 bounded by edges 120, 122 and 128 and corners 102, 104 and 108. FIG. 4 shows the surface 110 bounded by edges 118, 120 and 124 and corners 102, 104 and 106. FIG. 5 shows the surface 112 bounded by edges 118, 122 and 126 and corners 102, 106 and 108. FIGS. 1-5 illustrate the unique design of the example device 100 as each flat surface (110, 112, 114 and 116) and corner (102, 104, 106 and 108) provides a different massage experience due to their various dimensions.

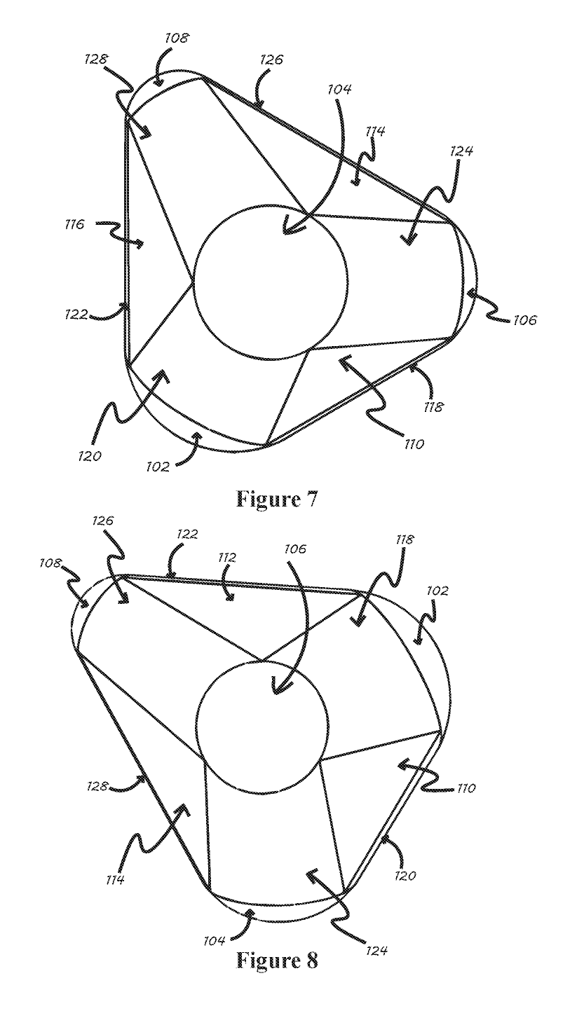

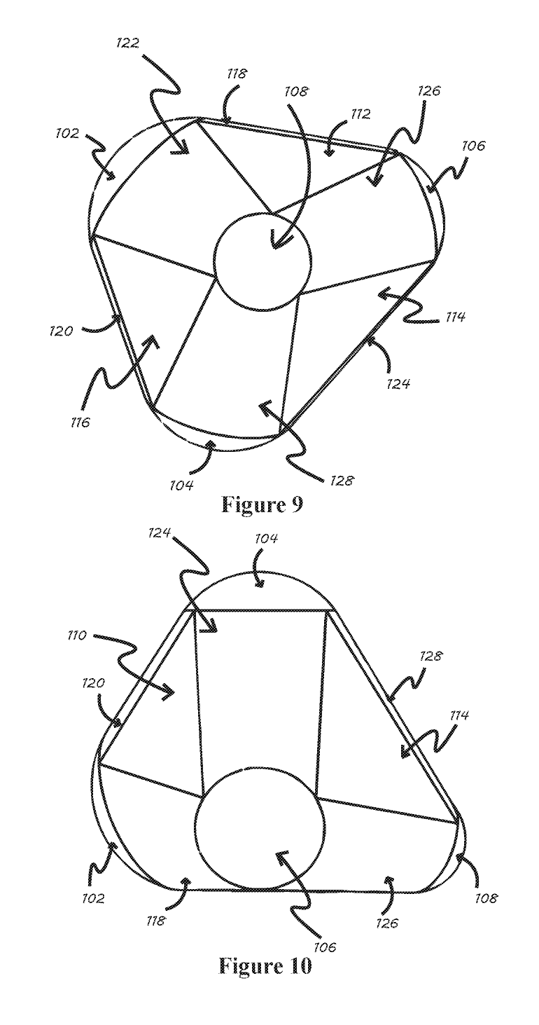

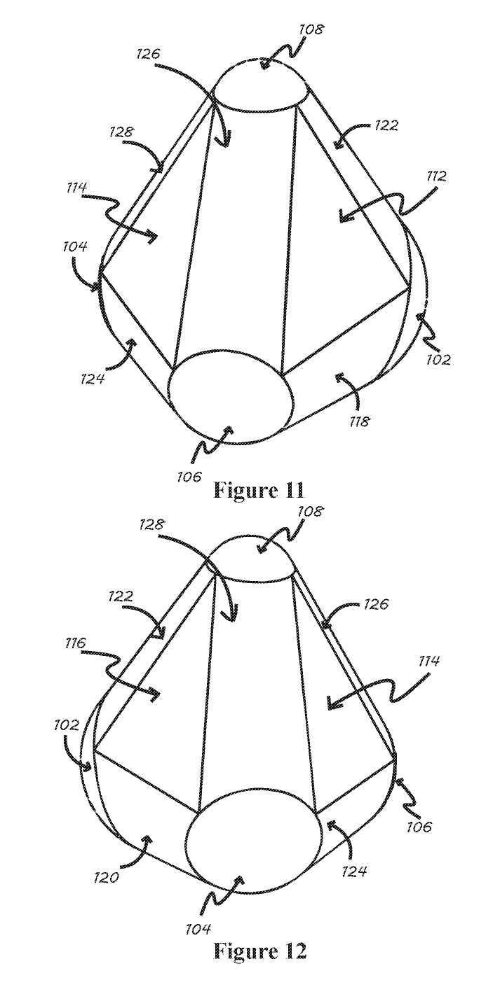

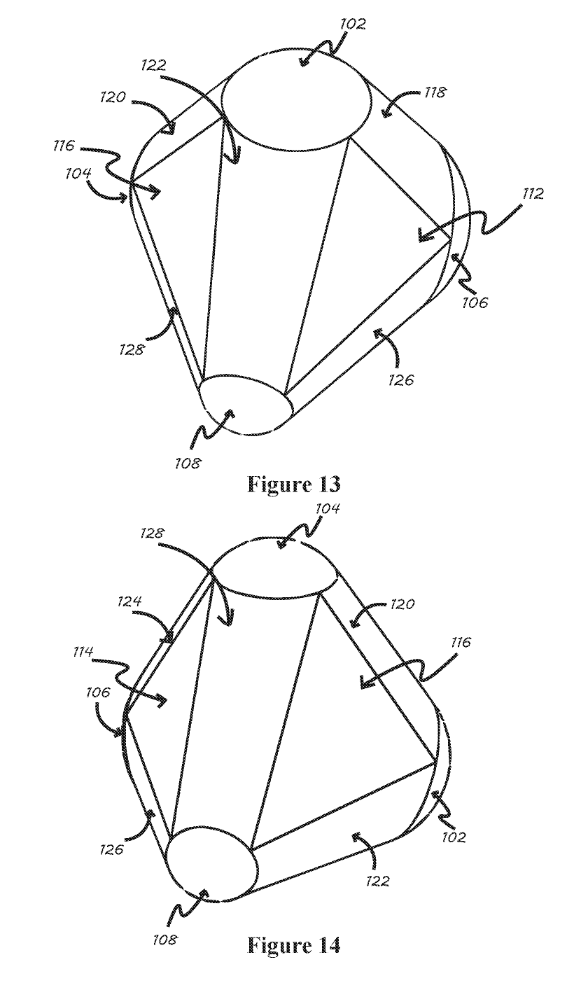

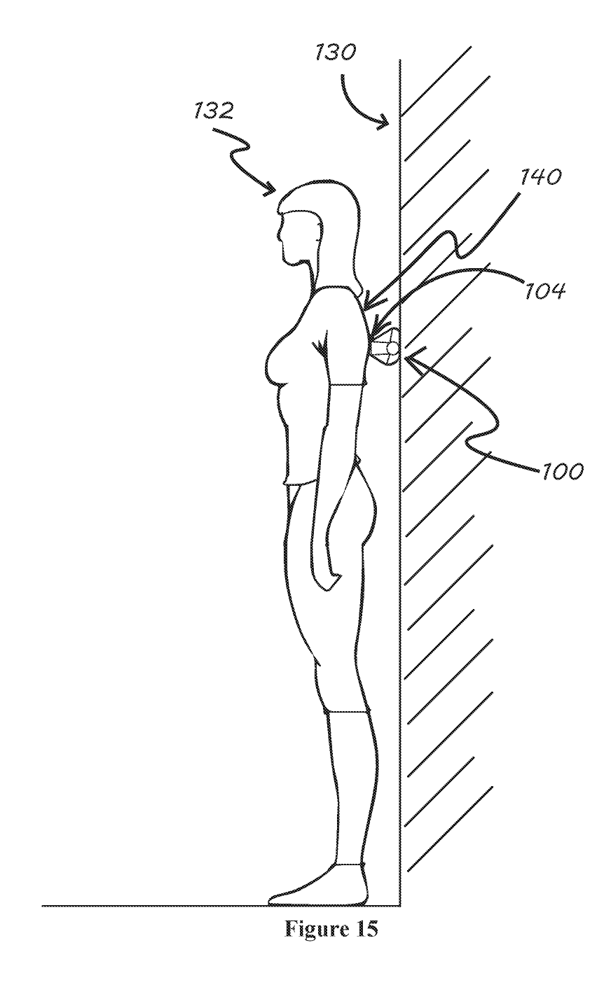

FIGS. 6-9 are perspective views of the different corners 102, 104, 106 and 108 of the massage device 100 in FIG. 1. FIG. 6 is a perspective view of the corner 102 of the example massage device 100 that has the largest radius of 2 inches in this example. The corner 104 has the next largest radius of 1.75 inches as illustrated in FIG. 7. The corner 106 has a radius of 1.5 inches in this example as illustrated in FIG. 8. The corner 108 has the smallest radius of 1 inch in this example as illustrated in FIG. 9. FIG. 11 is a perspective view of the example massage device in FIG. 1 with the corner 108 having the smallest radii facing upward with a full view of the corner 106 with second smallest radii. FIG. 12 is a 120 degree counterclockwise rotation of the massage device 100 shown in FIG. 11. FIG. 13 is a perspective view with corner 108 having the smallest radii facing upward of the example massage device 100 in FIG. 1. FIG. 14 is a perspective view of the example massage device 100 in FIG. 1 with the corner 104 having the second largest radii facing upward.

Increasing the radius size of a corner spreads the force of the massage device 100 over a larger area, thereby reducing the force felt by the user. Conversely, decreasing the radius size of a corner targets the pressure exerted by the massage device 100 thereby increasing the level of force felt by the user. The user can select the corner size and surface of the massage device 100 to effectively apply pressure to their body's trigger point. In this example, the smallest corner 108 is most effective for handheld applications where a person's palm would apply pressure to the flat surface 110 and the force would be exerted onto the muscle. This application is most effective for smaller muscles (i.e., the muscles in the hand primarily between the thumb and index finger) or to apply pressure around the shoulder socket to relieve pain suffered as a result of immobility after shoulder injuries. The largest corner 102 in this example is most effective for larger muscles (i.e., the gluteus maximus, quadriceps or hamstrings). These larger muscles can best be targeted by placing the surface 114 against a flat surface such as the ground, chair, or floor and using body weight to apply force to the massage device 100 to the affected muscle. The corner 102 in this example can also be used on a more sensitive or painful area since it will not massage as deep into the muscle as the smaller radii 108 and will therefore cause less discomfort. The corner 104 is most effective for muscles in the forearms where the surface 112 can be placed a flat surface such as a table for stability and a user can modulate the amount of body weight necessary to achieve the desired pressure from the massage device 100. The corner 106 is most effective for targeting specific knots within the shoulder blades. In this use case, the surface 116 can be placed against a flat surface (i.e., wall or floor), and a user can adjust their body to apply the amount of force from the massage device 100 that is most beneficial for their need.

FIG. 10 illustrates the example massage device 100 as it sits on a flat surface. Using the massage device 100 against flat surfaces (such as walls, chairs, floors, etc.) is desired as the flat surface in conjunction with the massage device 100 allows for effective muscle pain targeting. In FIG. 10, the user puts their body against the massage device 100, bringing a selected corner such as the corner 106 in this example into contact with a trigger point on the body. Once their body weight settles onto a corner, a feeling of decreased pain and/or tension in the area indicates successful myofascial pain release. The user can then repeat the process in the area on different trigger points and may adjust the massage device 100 for their desired pressure level in respect to the targeted area. In this example, the surface 116 is in contact with the flat surface, but any of the other surfaces 110, 112 or 114 may be placed in contact with the flat surface to put a respective corner in contact with a trigger point on the body.

FIG. 15 illustrates the massage device 100 placed against a wall 130 with a user 132 standing up to target the back/shoulder 140 using the corner 104. A wall is a preferable surface for self-massage treatment of hard to reach areas such as the back and shoulder as the device's flat surfaces ensure targeting of these typical areas of myofascial pain.

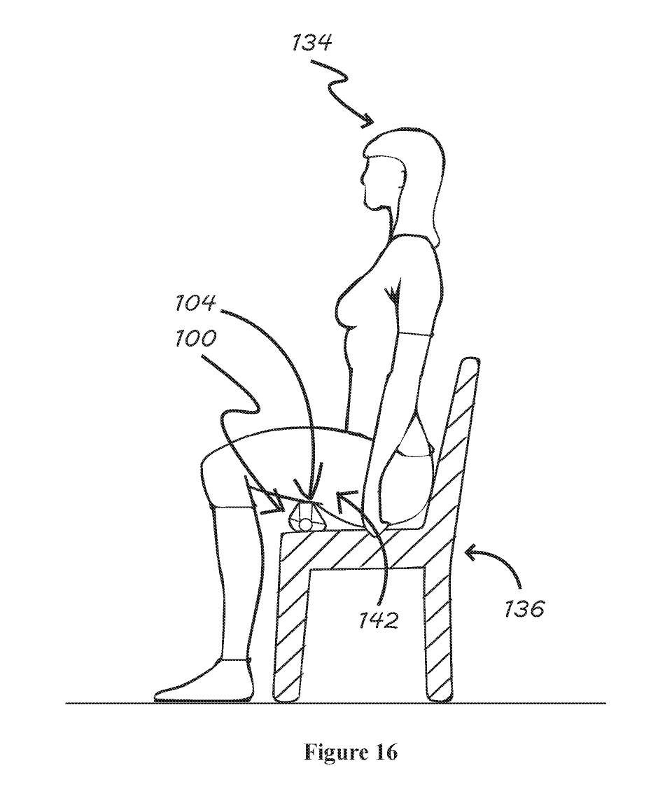

FIG. 16 illustrates the massage device 100 being used on a chair 136 with a user 134 sitting down on the corner 104 to target an upper leg area 142. Using the massage device 100 in this fashion may be common as it shows potential hands-free myofascial targeting that can be effective, specifically for example in the traditional work setup.

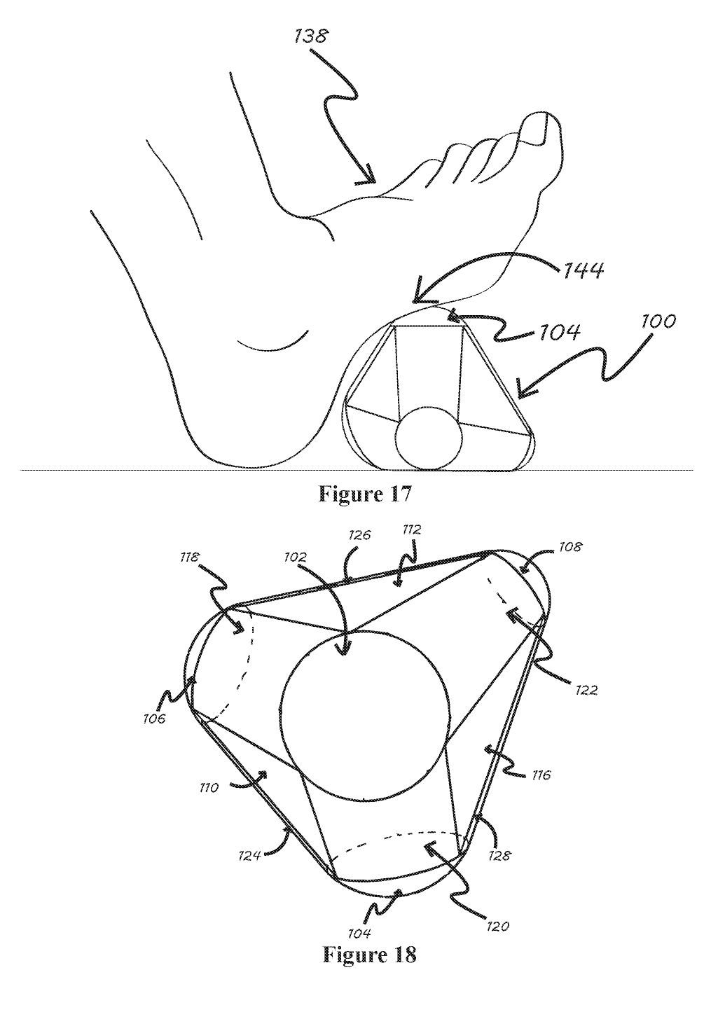

FIG. 17 illustrates the massage device 100 used on the floor with a user's foot 138 on top of the corner 104 to target plantar fascia that supports the arch of the foot 144. The massage device 100 is sized to effectively fit under the arch of a foot and a user can take advantage of the various pressure levels through rotating the device and using its large thermal range to help reduce heel pain.

In this example, the massage device 100 is cast from a mold using any suitably shape-retentive and semi-rigid material such as polyurethane, silicone, etc. The shore durometer ranges from 20-60 on the A scale to ensure the right balance of rigidity and flexibility. The material is chosen for its durability and softness and so the working surfaces are smooth but not slippery when used to apply pressure to trigger points of a user. Additionally, the material is chosen as it is non-abrasive to and non-reactive with the skin of a user.

The inner core of the massage device 100 in this example is solid but may be hollow to reduce the weight of the massage device 100. The inner core of the massage device 100 may also be a different material from the material of the outer surface to allow for different thermal properties or density. The weight of the device may range from 0.1 to 0.75 pounds depending on the inner core's make-up. Softer materials may allow the example massage tool to be propelled deeper into a muscle without causing excessive pain. The material used for the example massage tool 100 is durable and soft enough to effectively balance massage depth the user can attain while minimizing unnecessary or harmful pain.

The massage device may be frozen to provide a stiffer durometer while also being used as an icing tool to bring down the inflammation of an area. This property is best for sensitive areas that experience inflammation as well as knots in the fascia, i.e. plantar fasciitis, the inflammation of the thick tissue along the bottom of a foot.

Edges of the example massage device can also be used for rolling. A user may place a filleted edge of the example massage device on a part of the body that requires massage and use the corner radii as a pivot point in order to target a larger and more linear area. This technique of using the example massage device works best on smaller muscles such as forearm muscles for which a user may control the movement of the massage device 100 precisely.

The massage device 100 may be used in tandem with additional massage devices similar or identical to the massage device 100 to create a synchronous pain relieving system. This system using additional devices with the massage device 100 may target either the same muscle group at multiple points or multiple muscles at the same time. Similarly, the massage device 100 may be used to target pain via self-pressure from the edges or sides rolling using a radius as a pivot point.

The surfaces of the massage device 100 may be provided with an indentation to reflect more ergonomic use (such as a thumb hold) while maintaining stability against flat surfaces. This indentation may come in the form a small groove about the size of one finger on each flat surface to provide a firmer holding mechanism. These grooves may be shaped like a thumb, index and middle finger as those are the most likely fingers to be used on various flat surfaces while self-massaging. The indentations may be flexibly sized so that any finger can fit to provide maximum massaging flexibility.

The massage device 100 may be attached to various holding mechanisms to permit hands-free use. Such attachments include but are not limited to a holder that fits the massage device and sticks to a flat surface. Alternatively, a line or a hook may be attached via a hole through the center of the massage device 100. These attachments may create enhanced stability and allow extending the massage device 100 to reach difficult body positions. For example, a holder for the massage device 100 that could stick against a wall may enable easier self-massage therapy of the mid-back area given it is typically hard to reach. Similarly, attaching the massage device 100 to a hook or line may allow unique angled self-massages that are difficult on a flat wall or from a user's hand.

The above described massage device is a multi-sided, portable massage tool with a plurality of unique corners to provide precise targeting of myofascial muscle pains. The advantages of using the example massage device 100 include pain relief, improved mobility, versatility of unique corners, portability, ergonomics and precise trigger point targeting. The device is easy to use by professionals and nonprofessionals alike, whether to massage others or self-massage. Further, the example massage device 100 is lightweight, portable and ergonomic. The example massage device 100 provides precise muscle targeting and pain relief through its unique design. Unlike prior products, the device differentiates itself with various sized radii to target different muscles and a non-medicinal, approachable appearance.

While the foregoing written description of the device enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the device and following claims.

What is claimed is:

1. A myofascial massage device, comprising:
a solid body including a plurality of flat surfaces, the flat surfaces formed from a plurality of edges;
a plurality of radii at corners formed by the intersection of a subset of the flat surfaces, wherein at least two of the plurality of radii have different diameters; and
a base configured to be grasped within a user's hand.

2. The device of claim 1, wherein each of the plurality of flat surfaces is generally a triangular shape.

3. The device of claim 1, wherein the radii of the plurality of corners are between 0.5 inches to 3 inches.

4. The device of claim 1, wherein each of the plurality of edges are filleted and the edges are between 2 to 4 inches in length.

5. The device of claim 1, wherein the shore durometer of the device is between 20 to 60 on the A scale.

6. The device of claim 1, wherein the thermal properties of the solid body retain cold and heat for therapeutic use.

7. The device of claim 1, wherein the solid body is molded from shape-retentive, semi-rigid material.

8. The device of claim 7, wherein the material is silicone or polyurethane.

9. The device of claim 1, wherein the device weighs between 0.1-0.75 pounds.

10. The device of claim 1, wherein the body is either a solid or hollow.

11. The device of claim 1, wherein the materials of the device are non-abrasive to and non-reactive with skin.

12. The device of claim 1, wherein the solid body includes an inner core.

13. The device of claim 12, wherein the material of the inner core is different from the material of the rest of the body.

14. A method for myofascial massage, comprising:
positioning a massage device on a flat surface to apply pressure to a dysfunctional myofascial region of a user, wherein the massage device includes a solid body having a plurality of flat surfaces, the flat surfaces formed from a plurality of edges; a plurality of radii at corners formed by the intersection of a subset of the flat surfaces, wherein at least two of the plurality of radii have different diameters; and a base configured to be grasped within a user's hand; and
applying self-pressure on the base to push one of the plurality of radii of the massage device into contact with the subject.

15. The method of claim 14, wherein each of the plurality of flat surfaces is generally a triangular shape.

16. The method of claim 14, further comprising heating or cooling the massage device, wherein the thermal properties of the device retain cold and heat for therapeutic use.

17. The method of claim 14, wherein the solid body is molded from shape-retentive, semi-rigid material.

18. The method of claim 18, wherein the material is silicone or polyurethane.

19. The method of claim 14, wherein the materials of the device are non-abrasive to and non-reactive with skin.
